(19) United States
(12) Patent Application Publication
(10) Pub. No.: US 2026/0235072 A1
(43) Pub. Date: Aug. 13, 2026

(54) ACOUSTIC DAMPER ASSEMBLY FOR A GAS TURBINE ENGINE

(71) Applicant: General Electric Company, Schenectady, NY (US)

(72) Inventors: Ravindra Shankar Ganiger, Bengaluru (IN); Rachamadugu Sivaprasad, Bengaluru (IN); Kudum Shinde, Bengaluru (IN); Hiranya Kumar Nath, Bengaluru (IN); Nageswar Rao Ganji, Bengaluru (IN); Scott Alan Schimmels, Miamisburg, OH (US)

(21) Appl. No.: 17/951,248

(22) Filed: Sep. 23, 2022

(51) Int. Cl. F02C 7/045; F02C 7/28

(52) U.S. Cl. CPC F02C 7/045; F02C 7/28; F05D 2260/96

(57) ABSTRACT

A gas turbine engine including a turbomachine. The turbomachine including a compressor section, a combustion section, and a turbine section arranged in serial flow order and together defining a working gas flowpath. The gas turbine engine further including an acoustic damper assembly defining an air flow path in fluid communication with the working gas flow path. The acoustic damper assembly including a seal positioned within the air flowpath; and an acoustic damper in flow communication with the air flowpath, the acoustic damper defining an acoustic damper cavity having a resonance frequency to mitigate acoustic resonance around the seal during operation of the gas turbine engine.

### FIELD

The present disclosure relates to a gas turbine engine and, more specifically, to an acoustic damper assembly for a gas turbine engine.

### BACKGROUND

A gas turbine engine generally includes a fan and a turbomachine arranged in flow communication with one another. Additionally, the turbomachine of the gas turbine engine includes, in serial flow order, a compressor section, a combustion section, a turbine section, and an exhaust section. In operation, air is provided from the fan to an inlet of the compressor section where one or more axial compressors progressively compress the air until it reaches the combustion section to provide combustion gases. The combustion gases are routed from the combustion section to the turbine section. The flow of combustion gasses through the turbine section drives the turbine section and is then routed through the exhaust section, e.g., to the atmosphere.

Operating of the gas turbine engine may create undesired noise. Accordingly, improvements to address noise generation or to attenuate noise generated would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a close-up, cross sectional, schematic view of a compressor section and a combustion section of the exemplary gas turbine engine of FIG. 1.

FIG. 3 is a close-up, cross sectional view of an aft end of the compressor section and of a forward end of the combustion section of the exemplary gas turbine engine of FIG. 1.

FIG. 4 is a schematic view of a passive acoustic damper in accordance with an exemplary aspect of the present disclosure.

FIG. 5 is a schematic view of a passive acoustic damper in accordance with another exemplary aspect of the present disclosure.

FIG. 6 is a schematic view of an active acoustic damper in accordance with an exemplary aspect of the present disclosure.

FIG. 7 is a schematic view of an active acoustic damper in accordance with another exemplary aspect of the present disclosure.

FIG. 8 is a close-up, cross sectional view of an aft end of a compressor section and of a forward end of a combustion section in accordance with an exemplary aspect of the present disclosure.

FIG. 9 is a close-up, cross sectional view of an aft end of a compressor section and of a forward end of a combustion section in accordance with another exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., −er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

The terms “coupled,” “fixed,” and the like refer to both direct coupling and fixing, as well as indirect coupling and fixing, through one or more intermediate components or features, unless otherwise specified herein.

As used herein, the terms “first” and “second” may be used interchangeably to distinguish one component from another and are not intended to signify location or importance of the individual components.

As used herein, the term “rated speed” with reference to a gas turbine engine refers to a maximum rotational speed that the gas turbine engine may achieve while operating properly. For example, the gas turbine engine may be operating at the rated speed during maximum load operations, such as during takeoff operations.

The term “standard day operating condition” refers to ambient conditions of sea level altitude, 59 degrees Fahrenheit, and 60 percent relative humidity.

The present disclosure is generally related to a gas turbine engine including a turbomachine. The turbomachine includes a compressor section, a combustion section and a turbine section arranged in serial flow order. The compressor section, the combustion section, and the turbine section together define a working gas flowpath. The gas turbine engine further includes an air flowpath in flow communication with the working gas flowpath. Additionally, the gas turbine engine includes an acoustic damper assembly. The acoustic damper assembly includes a seal positioned within the air flowpath and an acoustic damper in flow communication with the air flowpath. The acoustic damper defines an acoustic damper cavity having a resonance frequency to mitigate acoustic resonance around the seal during operation of the gas turbine engine.

In general, the acoustic damper is configured as a Helmholtz resonator. Additionally, in various exemplary embodiments, the acoustic damper may a passive acoustic damper to passively mitigate acoustic resonance around the seal during operation of the gas turbine engine.

Additionally, or alternatively, the acoustic damper assembly may include an active acoustic damper that may actively mitigate acoustic resonance around the seal during operation of the gas turbine engine.

The acoustic damper assembly may mitigate acoustic resonance within the air flowpath to protect components within the air flowpath, such as the seal that may be positioned within the air flowpath. In such a manner, the acoustic damper assembly may reduce or eliminate component failures linked to acoustic resonance.

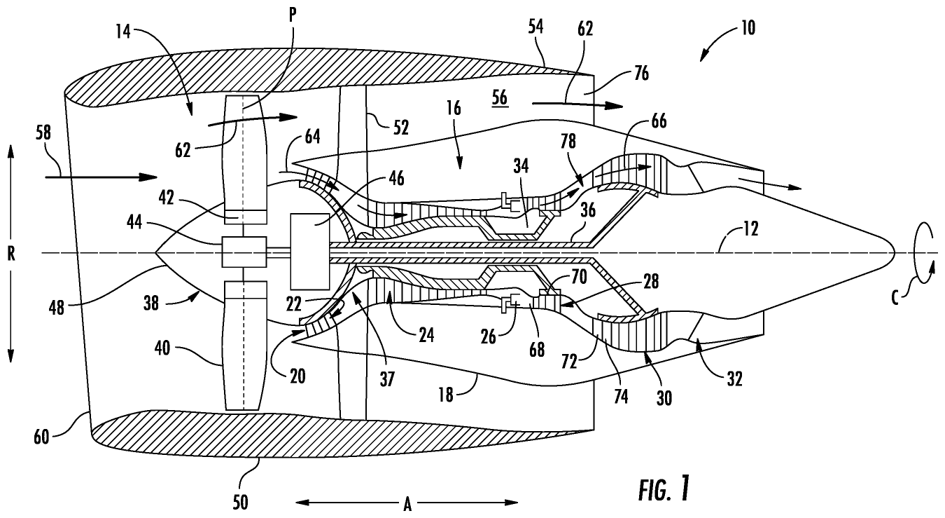

Referring now to the drawings, wherein identical numerals indicate the same elements throughout the figures, FIG. 1 is a schematic cross-sectional view of a gas turbine engine 10 in accordance with an exemplary embodiment of the present disclosure. More particularly, for the embodiment of FIG. 1, the gas turbine engine 10 is a high-bypass turbofan jet engine. As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (i.e., including the nacelle 50), in other embodiments, the gas turbine engine 10 may be an unducted gas turbine engine (such that the fan 38 is an unducted fan, and the outlet guide vanes 52 are cantilevered from the outer casing 18). Additionally, or alternatively, although the gas turbine engine 10 depicted is configured as a geared gas turbine engine (i.e., including the power gear box 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

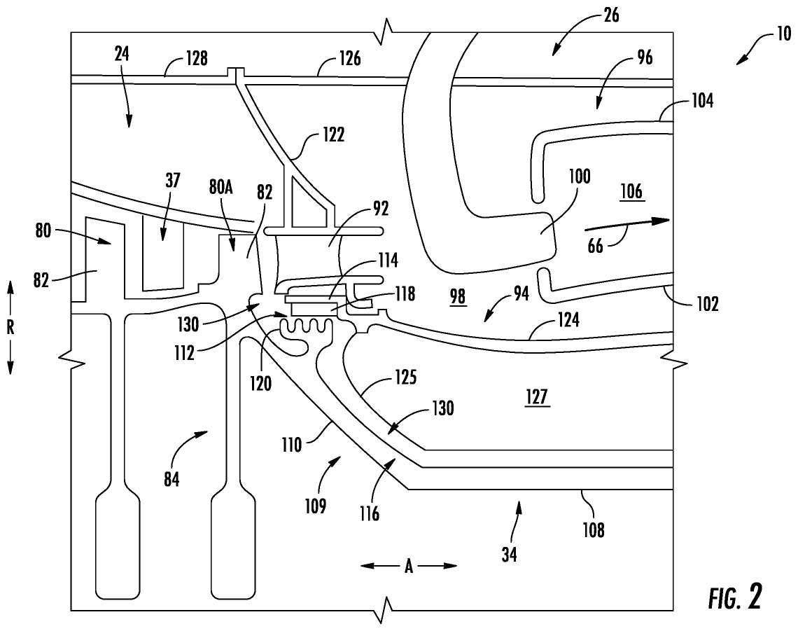

Referring now to FIG. 2, a schematic, cross-sectional view of a portion of the compressor section and of a portion of the combustion section 26 of the exemplary gas turbine engine 10 of FIG. 1 is provided. More specifically, FIG. 2 depicts an aft end of the HP compressor 24 of the compressor section, in addition to the combustion section 26.

As noted above, during operation of the gas turbine engine 10, an airflow through the working gas flowpath 37 of the gas turbine engine 10 is sequentially compressed as it flows through the compressor section, or more specifically, as it flow through the LP compressor 22 and the HP compressor 24. The compressed air from the compressor section is then provided to the combustion section 26, wherein at least a portion of the compressed air is mixed with fuel and burned to create the combustion gases 66. The combustion gases 66 flow from the combustion section 26 to the turbine section, and more specifically, sequentially through the HP turbine 28 and the LP turbine 30, for the embodiment depicted, driving the HP turbine 28 and the LP turbine 30 (see FIG. 1). The HP spool 34 is drivingly coupled to both the HP turbine 28 and the HP compressor 24.

Referring particularly to FIG. 2, the HP compressor 24 includes a plurality of compressor stages 80, with each compressor stage 80 including, e.g., a plurality of HP compressor rotor blades 82 and a rotor 84. Each of the various compressor stages 80 is drivingly coupled to the HP spool 34, such that the HP turbine 28 may drive the HP compressor 24 through the HP spool 34. Amongst the plurality of compressor stages 80 of HP compressor 24, is an aft-most compressor stage 80A located at an aft end of the HP compressor 24.

The aft-most compressor stage 80A provides compressed air to the combustion section 26. More specifically, for the embodiment depicted, the combustion section 26 includes a stage of discharge nozzles 92, a support assembly 94, and a combustor assembly 96. Further, the combustion section 26 defines a diffuser cavity 98, with the stage of discharge nozzles 92 located downstream of the compressor stages 80 of the HP compressor 24 and upstream of the diffuser cavity 98, such that compressed air from the aft-most compressor stage 80A is provided to the diffuser cavity 98 through the stage of discharge nozzles 92. The compressed air within the diffuser cavity 98 is, in turn, provided to the combustor assembly 96, where it is mixed with fuel and burned to generate the combustion gases 66. As is depicted, the combustor assembly 96 generally includes a fuel nozzle 100, an inner liner 102, and an outer liner 104, with the inner and outer liners 102, 104 together forming a combustion chamber 106.

It should be appreciated that the combustor assembly 96 may be configured as any suitable combustor assembly 96 for the gas turbine engine 10. For example, in certain embodiments, the combustor assembly 96 may be configured as an annular combustor assembly, a can combustor assembly, or a cannular combustor assembly.

Referring still to FIG. 2, as previously noted, the HP spool 34 is drivingly connected to the HP compressor 24. For the embodiment depicted, the HP spool 34 generally includes a central spool section including a central spool member 108 and a forward spool section 109 including a forward spool member 110. The central spool member 108 extends, for the embodiment depicted generally along the axial direction A at a location radially inward of the combustor assembly 96 of the combustion section 26. In certain exemplary embodiments, the central spool member 108 may define a substantially cylindrical shape. The forward spool member 110 extends generally from the central spool member 108 to the aft-most compressor stage 80A of the HP compressor 24 of the compressor section. More particularly, for the embodiment depicted, the forward spool member 110 forms, in part, a compressor discharge pressure seal 112.

Further, as is depicted, for the embodiment of FIG. 2, the support assembly 94 of the combustion section 26 also forms in part the compressor discharge pressure seal 112, such that the HP spool 34 forms the compressor discharge pressure seal 112 with the support assembly 94 of the combustion section 26. As is depicted, the support assembly 94 forms a stator portion 114 of the compressor discharge pressure seal 112 and the HP spool 34 forms a rotor portion 116 of the compressor discharge pressure seal 112 (the rotor portion 116 being rotatable relative to the stator portion 114). The stator portion 114 generally includes a seal pad 118 and the rotor portion 116 generally includes a plurality of seal teeth 120 configured to form a seal with the seal pad 118.

It should be appreciated, however, that in other exemplary embodiments, the compressor discharge pressure seal 112 may have any other suitable configuration. For example, in alternative exemplary embodiments the compressor discharge pressure seal 112 may be configured as a labyrinth seal.

Further, it will be appreciated that the support assembly 94 of the combustion section 26 is further configured for supporting the stage of discharge nozzles 92 and includes at least a portion positioned inward of the stage of discharge nozzles 92 along the radial direction R. More specifically, the support assembly 94 generally includes an outer discharge nozzle case 122 and an inner discharge nozzle case 124. The outer discharge nozzle case 122 extends from the stage of discharge nozzles 92 generally outwardly along the radial direction R and forward along the axial direction A. For the embodiment depicted, the outer discharge nozzle case 122 is coupled to an outer combustor casing 126 and an outer compressor casing 128. However, in other embodiments the outer discharge nozzle case 122 may be coupled to any other suitable component of the gas turbine engine 10.

Referring still to FIG. 2, the support assembly 94 additionally includes a seal flow separator 125. The seal flow separator 125 extends from inner discharge nozzle case 124 of the support assembly 94 to define in part an air flowpath 130 with the HP spool 34, and more specifically with the forward spool member 110 and a portion of the central spool member 108. Notably, the support assembly 94 further defines in part an air cavity 127 positioned inward of the inner discharge nozzle case 124 along the radial direction R, and the seal flow separator 125 separates the compressor discharge pressure seal 112 from the air cavity 127.

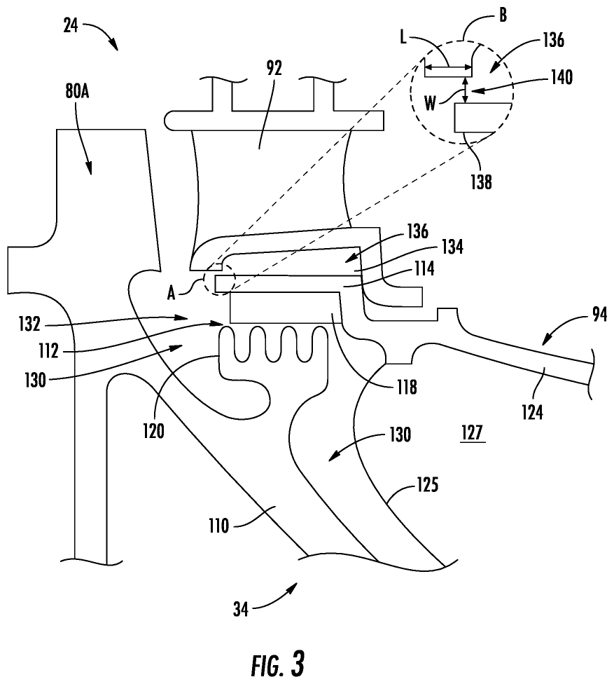

Referring now also to FIG. 3, a close-up view of an aft portion of the HP compressor 24 of the compressor section and a forward portion of the combustion section 26 of FIG. 2 is provided. As briefly mentioned above, the exemplary gas turbine engine 10 depicted generally defines at least in part the air flowpath 130. The air flowpath 130 is positioned at least in part between the HP spool 34 and the support assembly 94, and more specifically for the embodiment shown is defined at least in part by the support assembly 94 and the seal flow separator 125.

Further, for the embodiment depicted, the air flowpath 130 further extends past, or through, the compressor discharge pressure seal 112 and is in fluid communication with the working gas flowpath 37 of the gas turbine engine 10. More specifically, in the embodiment depicted the air flowpath 130 is in fluid communication with the working gas flowpath 37 at the HP compressor 24. More specifically, still, in the embodiment depicted the air flowpath 130 is in fluid communication with the working gas flowpath 37 at a location downstream of the aft-most compressor stage 80A and upstream of the stage of discharge nozzles 92.

Additionally, as will be explained in more detail below, the gas turbine engine 10 includes an acoustic damper assembly 132 extending in the circumferential direction C that is configured to mitigate acoustic resonance within the air flowpath 130. The acoustic damper assembly 132 includes the compressor discharge pressure seal 112, and an acoustic damper 134 in flow communication with the air flowpath 130. The acoustic damper 134 defines an acoustic damper cavity 136 and includes a neck 138 in flow communication with the air flowpath 130 and the acoustic damper cavity 136.

In particular, for the embodiment depicted, the acoustic damper cavity 136 is defined at least in part by the plurality of discharge nozzles 92 and the stator portion 114 of the compressor discharge pressure seal 112.

Briefly, as depicted in the callout Circle B, the neck 138 defines a neck opening 140 in flow communication with the air flowpath 130. The neck 138 of the acoustic damper 134 defines a width W (which may also be referred to as a diameter in the embodiment shown) and a length L. In the embodiment shown, the neck 138 defines a circular cross-sectional shape, and as such, the neck 138 further defines an area A′ equal to one half of the width W squared times

$$Pi ( {A}^{′} = {π ( \frac{W}{2} )}^{2} ) .$$

It will be appreciated that the acoustic damper cavity 136 defines a volume V that may be a relatively large volume when compared to a volume of the neck 138. As will be described in more detail below, the relatively large volume V of the acoustic damper cavity 136 may allow for acoustic damper 134 to attenuate acoustic resonance, such as acoustic resonance generated within the air flowpath 130 during of the gas turbine engine 10.

The neck 138, and more specifically, the neck opening 140, is configured to allow for an airflow through the air flowpath 130 to communicate with the acoustic damper cavity 136. In particular, the air flow through the air flowpath 130 may compress air within the volume V of the acoustic damper cavity 136, creating a vibration at a frequency. In such a manner, the acoustic damper cavity 136, and the neck 138, may act as a Helmholtz resonator. The frequency of the vibration may act to dampen acoustic waves through the air flowpath 130.

More specifically, as noted above, the acoustic damper 134 may be configured to mitigate acoustic resonance within the air flowpath 130 during an operation condition of the gas turbine engine 10. The operation condition may be an operation condition where acoustic resonance mitigation may be desired. For example, the acoustic damper 134 may be configured, via particular structural design, to mitigate acoustic resonance at a frequency between 100 Hz and 2000 Hz. The structure of the acoustic damper 134, and more specifically of the neck 138 and the acoustic damper cavity 136, may dictate the frequency of acoustic vibrations attenuated by the acoustic damper 134, according to a resonance frequency relationship as follows.

$$f = \frac{c}{2 \times π} \sqrt{\frac{{A}^{′}}{V \times L}}$$

In the resonance frequency relationship f is the frequency targeted by the acoustic damper 134 (e.g., between 100 Hz and 2000 Hz, such as between 100 Hz and 1000 Hz), c is the speed of sound of a gas flow (e.g., the airflow) over the neck opening 140 at the operating condition of the gas turbine engine 10, A′ is the area of the neck 138, L is the length of the neck 138, and V is the volume of the acoustic damper cavity 136.

Notably, the operation condition of the gas turbine engine 10 may be an operation of the gas turbine engine 10 at a rated speed during standard day operating condition. As will be appreciated, the speed of sound, c, of the gas flow over the neck opening 140 may depend on a location of the acoustic damper 134 and various characteristics of the gas turbine engine 10.

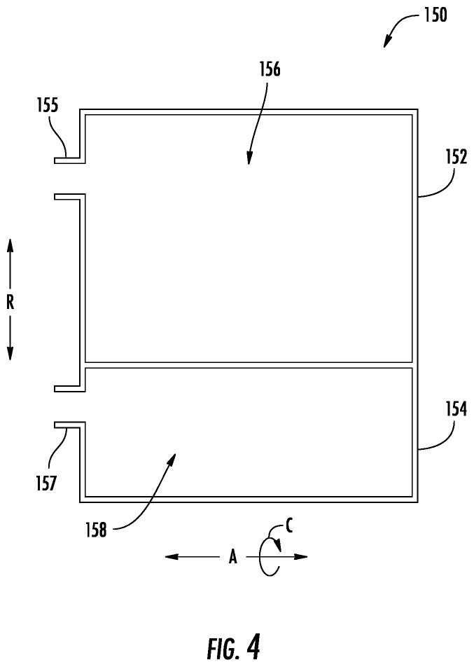

Referring now to FIG. 4, a simplified schematic cross-sectional view of a passive acoustic damper 150 is provided. It should be appreciated that the passive acoustic damper 150 may be incorporated into an acoustic damper assembly such as the acoustic damper assembly 132 of FIG. 2. In such a manner, it should be appreciated that the exemplary acoustic damper 134 of FIG. 2 may be configured as a passive acoustic damper 150.

The passive acoustic damper 150 may have structure that has been configured to passively mitigate acoustic resonance within an air flowpath (e.g., air flowpath 130 of FIG. 3). It should be appreciated that the terms “passive” or “passively” as used herein with reference to the passive acoustic damper 150 refers to a cavity being formed of structure that remains static during an operation condition of a gas turbine engine (e.g., the gas turbine engine 10 of FIG. 1), such that an internal volume of the passive acoustic damper 150 remains constant with the exception of minor fluctuations due to thermal growth or the like.

Generally, the passive acoustic damper 150 defines a radial direction R, an axial direction A, a circumferential direction C extending about the axial direction A, a first segment 152 that defines a first segment volume 156, and a second segment 154 that defines a second segment volume 158. Additionally, the first segment 152 is positioned radially outward of the second segment 154 along the radial direction R. It should be appreciated that the radial, axial and circumferential directions R, A, and C of the passive acoustic damper 150 may align with the radial, axial, and circumferential directions, respectively, of the gas turbine engine within which it is installed (see, e.g., gas turbine engine 10 of FIG. 1).

Further, it should be appreciated that the passive acoustic damper 150 includes a first neck 155 in flow communication with the first segment 152 and a second neck 157 that is in flow communication with the second segment 154.

As will be appreciated, the first segment 152 includes a first resonance frequency during operation of the gas turbine engine at an operating condition. In particular, the first resonance frequency may be determined by means of the resonance frequency relationship (described above), and more particularly for the exemplary embodiment, the characteristics of the first neck 155 (e.g., a width and a length of the first neck 155), the first segment volume 156, and a speed of sound of an air flow (see e.g., the air flow of FIG. 2) may be used to determine the first resonance frequency. The operating condition may be operation at a rated speed during standard day operating conditions.

Similarly, the second segment includes a second resonance frequency during operation of the gas turbine engine at the operation condition. In particular, the second resonance frequency may be determined by means of the resonance frequency relationship (described above), and more particularly for the exemplary embodiment, the characteristics of the second neck 157 (e.g., a width and a length of the second neck 157), the second segment volume 158, and a speed of sound of an air flow (see e.g., the air flow of FIG. 2) may be used to determine the second resonance frequency.

As is depicted in the exemplary embodiment, the first segment volume 156 is larger than the second segment volume 158. Thus, due to the resonance frequency relationship the first resonance frequency may be lower than the second resonance frequency during an operation condition of the gas turbine engine. Additionally, first segment volume 156 and the second segment volume 158 are positioned in such a manner that the passive acoustic damper 150 may passively mitigate acoustic resonance during operation of the gas turbine engine at the operating condition.

However, it should be appreciated that the first segment volume 156 being larger than the second segment volume 158 is provided by way of example only. In alternative exemplary embodiments the passive acoustic damper 150 may be configured in any suitable manner to passively mitigate acoustic resonance during operation of the gas turbine engine at the operating condition. For example, in alternative exemplary embodiments the characteristics of the first neck 155 (e.g., the width and the length of the first neck 155), the characteristics of the second neck 157 (e.g., the width and the length of the second neck 157), and the speed of sound of the air flow may additionally, or alternatively, be configured to passively mitigate acoustic resonance during operation of the gas turbine engine at the operating condition.

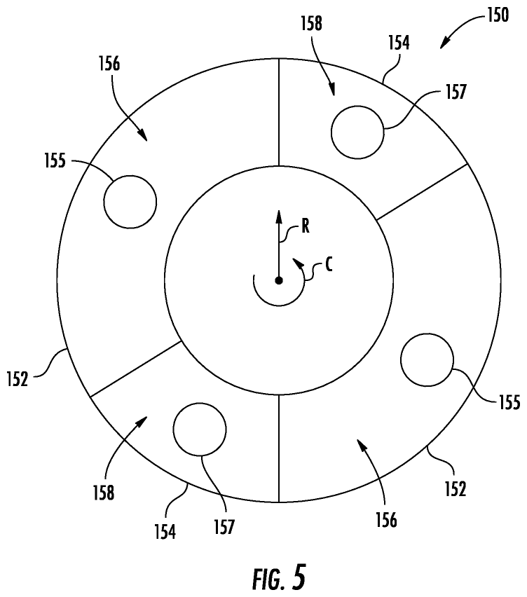

Referring now to FIG. 5, a schematic aft looking forward cross-sectional view of a passive acoustic damper 150 in accordance with another exemplary aspect of the present disclosure is provided. The exemplary passive acoustic damper 150 may be configured in substantially the same manner as the exemplary passive acoustic damper 150 of FIG. 4, and accordingly, the same or similar numbers may refer to the same or similar parts.

For example, the exemplary passive acoustic damper 150 of FIG. 5 generally defines a radial direction R, an axial direction A, and a circumferential direction C extending about the axial direction A. However, for the embodiment of FIG. 5 the passive acoustic damper 150 defines a plurality of first segments 152 and a plurality of second segments 154. Each of the plurality of first segments 152 define a first segment volume 156 and each of the plurality of second segments 154 define a second segment volume 158. It should be appreciated that as depicted, the first segment volumes 156 defined by the plurality of first segments 152 are larger than the second segment volumes 158 defined by of the plurality of second segments 154.

Additionally, for the embodiment of FIG. 5, the passive acoustic damper 150 includes a plurality of first necks 155 and a plurality of second necks 157. Each of the plurality of first necks 155 are positioned in such a manner that they are in flow communication with an adjacent first segment of the plurality of first segments 152. Similarly, each of the plurality of second necks 157 are positioned in such a manner that they are in flow communication with an adjacent second segment of the plurality of second segments 154.

As it will be appreciated, each of the plurality of first segments 152 include a first resonance frequency during operation of the gas turbine engine at an operating condition. In particular, the first resonance frequency may be determined by means of the resonance frequency relationship (described above), and more particularly for the exemplary embodiment, the characteristics of the plurality of first necks 155 (e.g., a width and a length of each of the plurality of first necks 155), the first segment volumes 156, and a speed of sound of an air flow (see e.g., the air flow of FIG. 2) may be used to determine the first resonance frequency. The operating condition may be operation at a rated speed during standard day operating conditions.

Similarly, each of the plurality of second segment 154 include a second resonance frequency during operation of the gas turbine engine at the operating condition. In particular, the second resonance frequency may be determined by means of the resonance frequency relationship (described above), and more particularly for the exemplary embodiment, the characteristics of the plurality of second necks 157 (e.g., a width and a length of each of the plurality of second necks 157), the second segment volumes 158, and a speed of sound of an air flow (see e.g., the air flow of FIG. 2) may be used to determine the second resonance frequency.

In the exemplary embodiment depicted, each of the first segment volumes 156 are larger than each of the second segment volumes 158. Thus, due to the resonance frequency relationship each of the first resonance frequencies of the plurality of first segments 152 may be lower than each of the second resonance frequencies of the plurality of second segments 154 during operation of the gas turbine engine at the operating condition. This configuration of the plurality of first segments 152 and the plurality of second segments 154, and more particularly, of the first segment volumes 156 and the second segment volumes 158 may passively mitigate acoustic resonance during operation of the gas turbine engine at the operating condition.

However, it should be appreciated that each of the first segment volumes 156 being larger than each of the second segment volumes 158 to passively mitigate acoustic resonance is provided by way of example only. In alternative exemplary embodiments the passive acoustic damper 150 may be configured in any suitable manner to passively mitigate acoustic resonance during operation of the gas turbine engine at the operating condition. For example, the characteristics of the plurality of first necks 155, the characteristics of the plurality of second necks 157, and the speed of sound of the air flow may additionally, or alternatively, be configured to passively mitigate acoustic resonance during operation of the gas turbine engine at an operating condition.

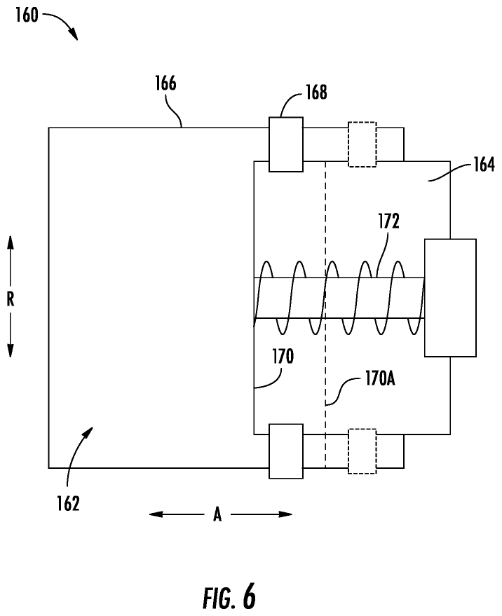

Referring now to FIG. 6, a simplified schematic cross-sectional view of an active acoustic damper 160 is provided. It should be appreciated that the active acoustic damper 160 may be incorporated into an acoustic damper assembly such as the acoustic damper assembly 132 of FIG. 2. In such a manner, it should be appreciated that the exemplary acoustic damper 134 of FIG. 2 may be configured as the active acoustic damper 160 described in more detail below.

The active acoustic damper 160 may have structure that has been configured to actively mitigate acoustic resonance within an air flowpath (e.g., air flowpath 130 of FIG. 3). It should be appreciated that the terms “active” or “actively” as used herein with reference to the active acoustic damper 160 refers to the cavity being formed of structure that is moveable during operation of a gas turbine engine (e.g., the gas turbine engine 10 of FIG. 1), such that an internal volume of the cavity changes more than would be afforded by minor fluctuations due to thermal growth or the like.

Generally, the active acoustic damper 160 defines a radial direction R, an axial direction A, and a circumferential direction C (not shown) extending about the axial direction A. The radial, axial, and circumferential direction R, A, and C of the active acoustic damper 160 may align with the radial, axial, and circumferential directions, respectively, of the gas turbine engine within which it is installed.

The active acoustic damper 160 generally includes a modulating piece 164, a housing 166, and a slider 168. The modulating piece 164 and the housing 166 together define a variable cavity 162, and more particularly, a variable wall 170 of the modulating piece 164 and the housing 166 define the variable cavity 162. Further, the modulating piece 164 includes a spring 172 coupled to the variable wall 170. It should be appreciated that the variable wall 170 is configured to slide to change a volume of the variable cavity 162. Moreover, it should be appreciated that the term “slide” as used herein refers to the variable wall 170 moving axially relative to the housing 166. For example, during operation of the gas turbine engine, a force, e.g., a pressure within the variable cavity 162, may slide the variable wall 170 (as depicted in phantom by variable wall 170A), and more specifically, a force may slide the variable wall 170 by compressing the spring 172 coupled to the variable wall 170 to increase the volume of the variable cavity 162.

It should be appreciated that during an operation condition of the gas turbine engine the change in volume of the variable cavity 162 may alter a resonance frequency produced by the variable cavity 162, and more specifically, this change in volume may be configured to mitigate acoustic resonance within the air flowpath of the gas turbine engine at different frequencies during various operation conditions where mitigation of the acoustic resonance within the air flowpath is desired.

Additionally, it should be appreciated that in alternative exemplary embodiments the modulating piece 164 may be formed integrally with the housing 166.

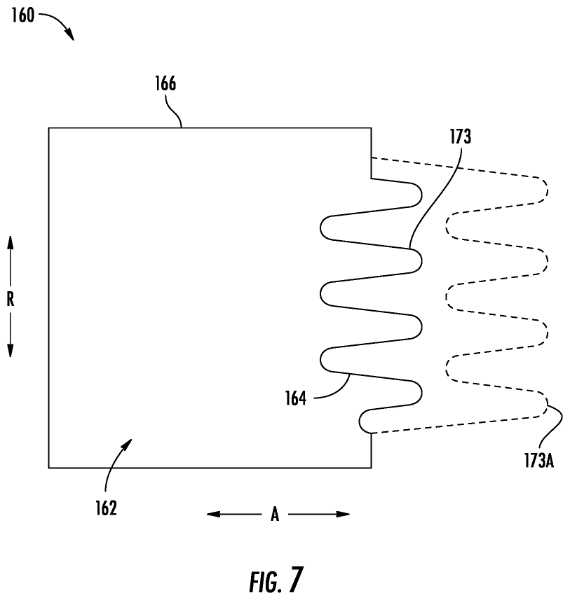

Referring now specifically to FIG. 7, a simplified cross-sectional view of an active acoustic damper 160 in accordance with another exemplary aspect of the present disclosure is provided. The exemplary active acoustic damper 160 may be configured in substantially the same manner as the exemplary active acoustic damper 160 of FIG. 6, and accordingly, the same or similar numbers may refer to the same or similar parts.

For example, the exemplary active acoustic damper 160 of FIG. 7 generally defines a radial direction R, an axial direction A, and a circumferential direction C (not shown) extending about the axial direction A. Additionally, the active acoustic damper 160 of FIG. 7 includes a housing 166 and a modulating piece 164 that together define a variable cavity 162. However, for the embodiment of FIG. 7, the modulating piece 164 now includes a flexible wall 173 that is configured to change a volume of the variable cavity 162 during an operation condition. It should be appreciated that the flexible wall 173 may be formed of graphene plates, non-metallic polymer based materials, high temperature shape memory alloys, or any other suitable material.

Additionally, during operation of the gas turbine engine, a force, e.g., a pressure within the variable cavity 162, may expand the flexible wall 173 (as depicted in phantom by flexible wall 173A) and increase the volume of the variable cavity 162.

It should be appreciated that during operation of the gas turbine engine, the change in volume of the variable cavity 162 may alter a resonance frequency produced by the variable cavity 162, and more specifically, this change in volume may be configured to mitigate acoustic resonance within the air flowpath of the gas turbine engine at different frequencies during various operation conditions where mitigation of the acoustic resonance within the air flowpath is desired.

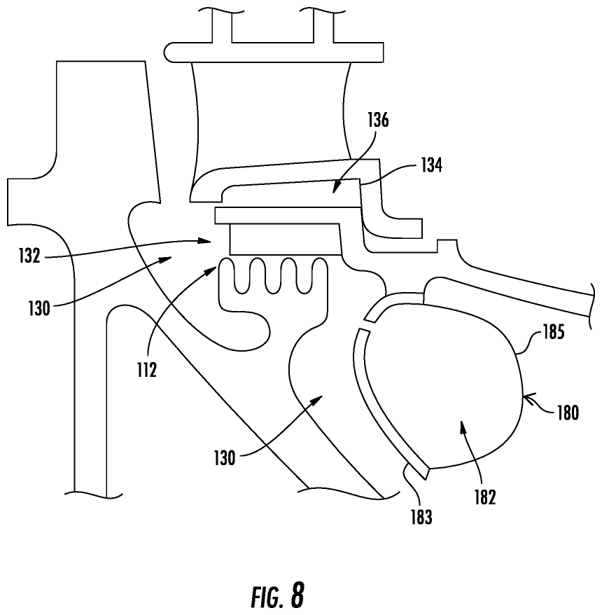

Referring now to FIG. 8, a close-up view of an aft portion of a HP compressor of a compressor section and a forward portion of a combustion section in accordance with another exemplary aspect of the present disclosure is provided. It should be appreciated that the exemplary the compressor section and combustion section may be incorporated in a gas turbine engine such as the gas turbine engine 10 of FIG. 1. Additionally, the exemplary acoustic damper assembly 132 of FIG. 8 may be configured in substantially the same manner as acoustic damper assembly 132 of FIG. 3, and accordingly, the same or similar numbers may refer to the same or similar parts.

For example, the acoustic damper assembly 132 generally includes a compressor discharge pressure seal 112, and an acoustic damper 134 in flow communication with an air flowpath 130. However, for the embodiment of FIG. 8, the acoustic damper 134 is now configured as an upstream acoustic damper 134 located upstream of the compressor discharge pressure seal 112. Additionally, the upstream acoustic damper 134 includes an upstream acoustic damper cavity 136 that generally has an upstream resonance frequency configured to mitigate the acoustic resonance upstream of the compressor discharge pressure seal 112.

The acoustic damper assembly 132 further includes a downstream acoustic damper 180 located downstream of the compressor discharge pressure seal 112. The downstream acoustic damper 180 defines a downstream acoustic damper cavity 182 that has a downstream resonance frequency configured to mitigate the acoustic resonance downstream of the compressor discharge pressure seal 112.

In the embodiment depicted, the downstream acoustic damper 180 is formed of a seal flow separator 183 and a damper liner 185, with the seal flow separator 183 and damper liner 185 together defining the downstream acoustic damper cavity 182.

It should be appreciated that the upstream acoustic damper cavity 136 and the downstream acoustic damper cavity 182 may be configured as any suitable acoustic damper cavity, such as the acoustic damper cavities described in FIGS. 4 through 7.

Additionally, it should be appreciated, that the upstream acoustic damper cavity 136 has an upstream volume and the downstream acoustic damper cavity 182 has a downstream volume. The upstream volume is configured to be lower than the downstream volume. For example, the upstream volume may be at least 20% of the downstream volume (i.e., upstream volume is greater than or equal to 0.20× downstream volume), at least 30% of the downstream volume, at least 45% of the downstream volume, such as up to 70% of the downstream volume, such as up to 70% of the downstream volume.

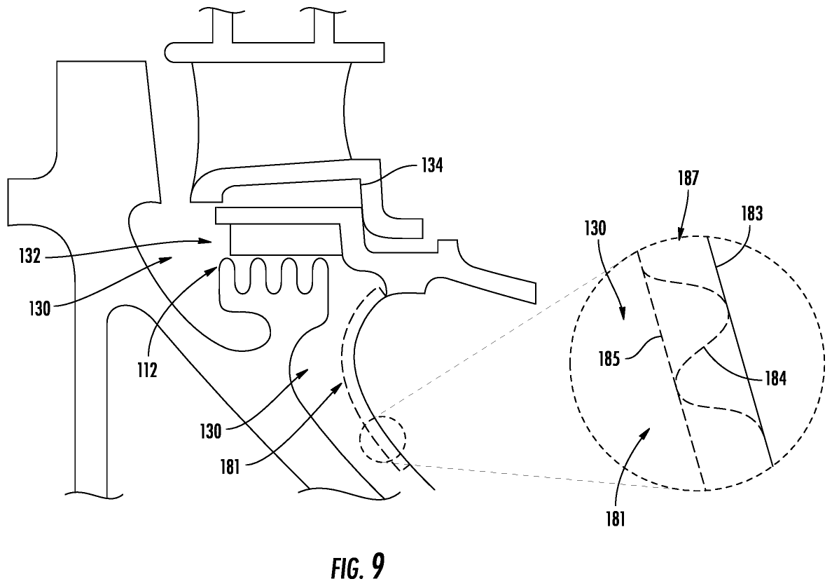

Referring now to FIG. 9, a close-up view of an aft portion of a HP compressor of a compressor section and a forward portion of a combustion section in accordance with another exemplary aspect of the present disclosure is provided. It should be appreciated that the exemplary the compressor section and combustion section may be incorporated in a gas turbine engine such as the gas turbine engine 10 of FIG. 1. Additionally, the exemplary acoustic damper assembly 132 of FIG. 9 may be configured in substantially the same manner as acoustic damper assembly 132 of FIG. 8, and accordingly, the same or similar numbers may refer to the same or similar parts.

For example, the acoustic damper assembly 132 generally includes a compressor discharge pressure seal 112, an upstream acoustic damper 134 positioned upstream of the compressor discharge pressure seal 112, and a downstream acoustic damper 180 positioned downstream of the compressor discharge pressure seal 112. However, for the exemplary embodiment of FIG. 9 the downstream acoustic damper 180 is now an acoustic baffle damper 181. The acoustic baffle damper 181 is formed of a seal flow separator 183 and a damper liner 185, with the seal flow separator and damper liner 185 together defining a baffle cavity 187. Additionally, the acoustic baffle damper 181 includes a plurality of baffles 184 positioned in a serpentine manner within the acoustic baffle damper 181. As depicted, the plurality of baffles 184 and the damper liner 185 define a plurality of liners that fluidly couple an air flowpath 130 of the gas turbine engine and the baffle cavity 187 in such a manner that the acoustic baffle damper 181 is configured to mitigate acoustic resonance within the air flowpath 130, and more specifically downstream of the compressor discharge pressure seal 112.

It should be appreciated that the plurality of baffles 184 may be coupled to or formed integrally with the air flowpath 130. Additionally, or alternatively, it should be appreciated that the acoustic baffle damper 181 may be coupled to or formed integrally with a downstream acoustic damper (e.g., the downstream acoustic damper 180 of FIG. 8) and configured to mitigate acoustic resonance within the air flowpath 130, and more specifically, downstream of the compressor discharge pressure seal 112.

Further aspects are provided by the subject matter of the following clauses:

A gas turbine engine comprising: a turbomachine comprising a compressor section, a combustion section, and a turbine section arranged in serial flow order and together defining a working gas flowpath; an acoustic damper assembly defining an air flowpath in fluid communication with the working gas flow path, the acoustic damper assembly comprising; a seal positioned within the air flowpath; and an acoustic damper in flow communication with the air flowpath, the acoustic damper defining an acoustic damper cavity having a resonance frequency to mitigate acoustic resonance around the seal during operation of the gas turbine engine.

The gas turbine engine of any preceding clause, wherein the compressor section comprises a spool, wherein the combustion section comprises a support assembly, and wherein the air flowpath is positioned between the spool and the support assembly.

The gas turbine engine of any preceding clause, wherein the compressor section comprises a high pressure compressor, wherein the spool is a high pressure spool, wherein the air flowpath is in fluid communication with the working gas flowpath at the high pressure compressor, and wherein the seal is a compressor discharge pressure seal.

The gas turbine engine of any preceding clause, wherein the compressor section comprises a high pressure compressor with an aft-most compressor stage, wherein the combustion section includes a plurality of discharge nozzles downstream of the aft-most compressor stage, wherein the acoustic damper cavity is defined at least in part by the plurality of discharge nozzles.

The gas turbine engine of any preceding clause, wherein the acoustic damper is located upstream of the seal, and wherein the acoustic damper cavity is located upstream of the seal.

The gas turbine engine of any preceding clause, wherein the acoustic damper assembly further comprises a downstream acoustic damper located downstream of the seal, the downstream acoustic damper defines a downstream acoustic damper cavity having a resonance frequency to mitigate acoustic resonance downstream of the seal.

The gas turbine engine of any preceding clause, wherein the acoustic damper cavity comprises an upstream volume, wherein the downstream acoustic damper cavity comprises a downstream volume, and wherein the upstream volume is at least 20% and up to 80% of the downstream volume.

The gas turbine engine of any preceding clause, wherein the downstream acoustic damper is an acoustic baffle damper.

The gas turbine engine of any preceding clause, wherein the acoustic damper assembly defines a radial direction and a circumferential direction, wherein the acoustic damper is a passive acoustic damper, and wherein the passive acoustic damper defines a first segment having a first resonance frequency and a second segment having a second resonance frequency.

The gas turbine engine of any preceding clause, wherein the first segment is positioned radially outward of the second segment along the radial direction, and wherein the first resonance frequency is lower than the second resonance frequency.

The gas turbine engine of any preceding clause, wherein the first segment and the second segment are positioned along the circumferential direction within the acoustic damper cavity, and wherein the first resonance frequency is lower than the second resonance frequency.

The gas turbine engine of any preceding clause, wherein the acoustic damper is an active acoustic damper that comprises a housing and a modulating piece that together define a variable cavity.

The gas turbine engine of any preceding clause, wherein the resonance frequency mitigates acoustic resonance at a frequency between 100 Hz and 2000 Hz.

An acoustic damper assembly for a gas turbine engine defining a working gas flowpath and an air flowpath in fluid communication with the working gas flowpath, the acoustic damper assembly comprising: a seal positioned within the air flowpath; and an acoustic damper in flow communication with the air flowpath, the acoustic damper defining an acoustic damper cavity having a resonance frequency to mitigate an acoustic resonance within the air flowpath during operation of the gas turbine engine.

The acoustic damper assembly of any preceding clause, wherein the acoustic damper is located upstream of the seal, and wherein the acoustic damper cavity is located upstream of the seal.

The acoustic damper assembly of any preceding clause, wherein the acoustic damper assembly further comprises a downstream acoustic damper located downstream of the seal, the downstream acoustic damper defines a downstream acoustic damper cavity having a having a resonance frequency to mitigate acoustic resonance downstream of the seal.

The acoustic damper assembly of any preceding clause, wherein the acoustic damper cavity comprises an upstream volume, wherein the downstream acoustic damper cavity comprises a downstream volume, and wherein the upstream volume is at least 20% and up to 80% of the downstream volume.

The acoustic damper assembly of any preceding clause, wherein the acoustic damper assembly defines a radial direction and a circumferential direction, wherein the acoustic damper is a passive acoustic damper, and wherein the passive acoustic damper defines a first segment having a first resonance frequency and a second segment having a second resonance frequency.

The acoustic damper assembly of any preceding clause, wherein the first segment is positioned radially outward of the second segment along the radial direction, and wherein the first resonance frequency is lower than the second resonance frequency.

The acoustic damper assembly of any preceding clause, wherein the first segment and the second segment are positioned along the circumferential direction within the acoustic damper cavity, and wherein the first resonance frequency is lower than the second resonance frequency.

The acoustic damper assembly of any preceding clause, wherein the acoustic damper is configured as a Helmholtz resonator.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine comprising:
a turbomachine comprising a compressor section, a combustion section, and a turbine section arranged in serial flow order and together defining a working gas flowpath;
an acoustic damper assembly defining an air flowpath in fluid communication with the working gas flow path, the acoustic damper assembly comprising;
a seal positioned within the air flowpath; and
an acoustic damper in flow communication with the air flowpath, the acoustic damper defining an acoustic damper cavity having a resonance frequency to mitigate acoustic resonance around the seal during operation of the gas turbine engine.

2. The gas turbine engine of claim 1, wherein the compressor section comprises a spool, wherein the combustion section comprises a support assembly, and wherein the air flowpath is positioned between the spool and the support assembly.

3. The gas turbine engine of claim 2, wherein the compressor section comprises a high pressure compressor, wherein the spool is a high pressure spool, wherein the air flowpath is in fluid communication with the working gas flowpath at the high pressure compressor, and wherein the seal is a compressor discharge pressure seal.

4. The gas turbine engine of claim 2, wherein the compressor section comprises a high pressure compressor with an aft-most compressor stage, wherein the combustion section includes a plurality of discharge nozzles downstream of the aft-most compressor stage, wherein the acoustic damper cavity is defined at least in part by the plurality of discharge nozzles.

5. The gas turbine engine of claim 1, wherein the acoustic damper is located upstream of the seal, and wherein the acoustic damper cavity is located upstream of the seal.

6. The gas turbine engine of claim 5, wherein the acoustic damper assembly further comprises a downstream acoustic damper located downstream of the seal, the downstream acoustic damper defines a downstream acoustic damper cavity having a resonance frequency to mitigate acoustic resonance downstream of the seal.

7. The gas turbine engine of claim 6, wherein the acoustic damper cavity comprises an upstream volume, wherein the downstream acoustic damper cavity comprises a downstream volume, and wherein the upstream volume is at least 20% and up to 80% of the downstream volume.

8. The gas turbine engine of claim 6, wherein the downstream acoustic damper is an acoustic baffle damper.

9. The gas turbine engine of claim 1, wherein the acoustic damper assembly defines a radial direction and a circumferential direction, wherein the acoustic damper is a passive acoustic damper, and wherein the passive acoustic damper defines a first segment having a first resonance frequency and a second segment having a second resonance frequency.

10. The gas turbine engine of claim 9, wherein the first segment is positioned radially outward of the second segment along the radial direction, and wherein the first resonance frequency is lower than the second resonance frequency.

11. The gas turbine engine of claim 9, wherein the first segment and the second segment are positioned along the circumferential direction within the acoustic damper cavity, and wherein the first resonance frequency is lower than the second resonance frequency.

12. The gas turbine engine of claim 1, wherein the acoustic damper is an active acoustic damper that comprises a housing and a modulating piece that together define a variable cavity.

13. The gas turbine engine of claim 11, wherein the resonance frequency mitigates acoustic resonance at a frequency between 100 Hz and 2000 Hz.

14. An acoustic damper assembly for a gas turbine engine defining a working gas flowpath and an air flowpath in fluid communication with the working gas flowpath, the acoustic damper assembly comprising:
a seal positioned within the air flowpath; and
an acoustic damper in flow communication with the air flowpath, the acoustic damper defining an acoustic damper cavity having a resonance frequency to mitigate an acoustic resonance within the air flowpath during operation of the gas turbine engine.

15. The acoustic damper assembly of claim 14, wherein the acoustic damper is located upstream of the seal, and wherein the acoustic damper cavity is located upstream of the seal.

16. The acoustic damper assembly of claim 15, wherein the acoustic damper assembly further comprises a downstream acoustic damper located downstream of the seal, the downstream acoustic damper defines a downstream acoustic damper cavity having a having a resonance frequency to mitigate acoustic resonance downstream of the seal.

17. The acoustic damper assembly of claim 16, wherein the acoustic damper cavity comprises an upstream volume, wherein the downstream acoustic damper cavity comprises a downstream volume, and wherein the upstream volume is at least 20% and up to 80% of the downstream volume.

18. The acoustic damper assembly of claim 14, wherein the acoustic damper assembly defines a radial direction and a circumferential direction, wherein the acoustic damper is a passive acoustic damper, and wherein the passive acoustic damper defines a first segment having a first resonance frequency and a second segment having a second resonance frequency.

19. The acoustic damper assembly of claim 18, wherein the first segment is positioned radially outward of the second segment along the radial direction, and wherein the first resonance frequency is lower than the second resonance frequency.

20. The acoustic damper assembly of claim 18, wherein the first segment and the second segment are positioned along the circumferential direction within the acoustic damper cavity, and wherein the first resonance frequency is lower than the second resonance frequency.
